(19) United States
(12) Patent Application Publication
(10) Pub. No.: US 2007/0261902 A1
(43) Pub. Date: Nov. 15, 2007

(54) Electric motor vehicle

(76) Inventor: George Margoudakis, Hurley, NY (US)

Correspondence Address: JOHN MAIER, III, 660 AARON COURT, KINGSTON, NY, 12401, US

(21) Appl. No.: 11/434,707

(22) Filed: May 15, 2006

(51) Int. Cl. B60L 8/00

(52) U.S. Cl. 180/65.3

(57) ABSTRACT

An electric motor vehicle is provided which includes an apparatus for generating electric power from the movement of the motor vehicle. A pair of front wheels and a pair of rear wheels are mounted on the frame. At least one of the wheels includes a brake drum which extends outside of the wheel toward the opposite side of the vehicle. An electric generation unit is mounted on the frame and has a generator shaft with a generator pulley mounted on the generator shaft. The generator pulley and the drive pulley are aligned with one another. A drive belt extends around and engages both the drive pulley and the generator pulley. At least one of the rear wheels is driven by an electric drive assembly. The electric generation unit is connected to the batteries by a power line with a switch in it. A speed sensor is mounted on the electric drive assembly and the speed sensor is connected electrically to the switch to open and close the switch.

### BACKGROUND OF THE INVENTION

1. Field of the Invention

This invention relates to an electric motor vehicle including apparatus for generating electric power from the movement of the motor vehicle, and more specifically, to an apparatus for generating electric power by use of an extended brake drum for use as a drive wheel.

2. Prior Art

With the increased concern over the cost and availability of petroleum products, there is increasing interest in the use of vehicles powered by an electric motor. To generate electricity so as to freshen the batteries used to power the electric motor, various devices have been proposed. The benefit from those periods when the vehicle is coasting is discussed in the AL-DOKHI Patent, U.S. Pat. No. 5,921,334, a separate set of wheels is lowered to the road surface to generate power. A winch is used to withdrawal the separate set of wheels from the road when use of the generation system is not desired.

The SHULBACK ET. AL. Patent, U.S. Pat. No. 5,215,156, teaches a system for driving electric generators from the rotation of an axial of a vehicle. STULBACH ET AT. AL. includes a device to activate the generation system when the vehicle is proceeding downhill.

The GOTTA Patent, U.S. Pat. No. 6,886,647, utilizes a dual axial arrangement. Two motors are powered but usually only one motor is in use. The differential in the rear axial is connected to a generator to charge the batteries which are used to supply power to the motor, but the batteries being charged are those batteries which are not in use at the time of charging.

The MEDEN Patent, U.S. Pat. No. 741,587, uses a gear system with a separate motor driving each of two wheels.

None of the prior art uses an extension of a brake drum for use as a drive pulley for activation of a generating system.

### OBJECTS

The objects of this invention are as follows:
1. To provide an apparatus to power an electric generation unit in a motor vehicle.
2. To provide apparatus for an electric generation unit that utilizes, at least to some degree, existing parts of a vehicle.
3. To provide an apparatus to power an electric generation unit that utilizes a brake drum as a drive pulley.
4. To provide an apparatus for powering an electric generation unit in a motor vehicle that is both durable and economical.

The aforementioned objects, features and advantages of the invention will, in part, be pointed out with particularity, and will in part, become obvious from the following more detailed description of the invention, taken in conjunction with the accompanying drawings which form an integral part thereof.

### SUMMARY

An electric motor vehicle is provided which includes an apparatus for generating electric power from the movement of the motor vehicle. A frame is mounted on four wheels. At least one of the four wheels has a brake drum which extends outside of the vehicle to form a drive pulley. An electric generation unit with a generator pulley is mounted on the frame. The electric generation unit supplies electric power to an electric drive assembly. A drive belt engages both the drive pulley and the generator pulley.

### BRIEF DESCRIPTION OF THE DRAWINGS

FIG. 1 is a pictorial view partially broken away of the rear end of a motor vehicle showing the extended brake drum and electric generation unit with a drive belt connecting them.

FIG. 2 is a block diagram showing the mechanical and electrical connections of the components of the motor vehicle including the electric generation unit.

### BRIEF DESCRIPTION OF THE NUMERALS

| NUMERAL | DESCRIPTION |
|---|---|
| 11 | Motor Vehicle |
| 13 | Body |
| 15 | Frame |
| 17 | Four Wheels |
| 19 | Left Rear Wheel |
| 21 | Right Rear Wheel |
| 23 | Left Front Wheel |
| 25 | Right Front Wheel |
| 27 | Front Axial |
| 29 | Front Supports |
| 31 | Rear Axial |
| 33 | Differential |
| 35 | Rear Supports |
| 37 | Break Drums |
| 39 | Drive Pulley |
| 41 | Electric Generation Unit |
| 43 | Generator Shaft |
| 45 | Generator Pulley |
| 47 | Drive Belt |
| 49 | Accelerator |
| 51 | Voltage Regulator |
| 53 | Drive Motor |
| 54 | Motor Shaft |
| 55 | Transmission |
| 56 | Electric Drive Assembly |
| 57 | Transmission Shaft |
| 58 | Power Line |
| 59 | Batteries |
| 61 | Speed Sensor |
| 65 | Drive Shaft |
| 67 | Switch |

### DETAILED DESCRIPTION OF THE PREFERRED EMBODIMENT

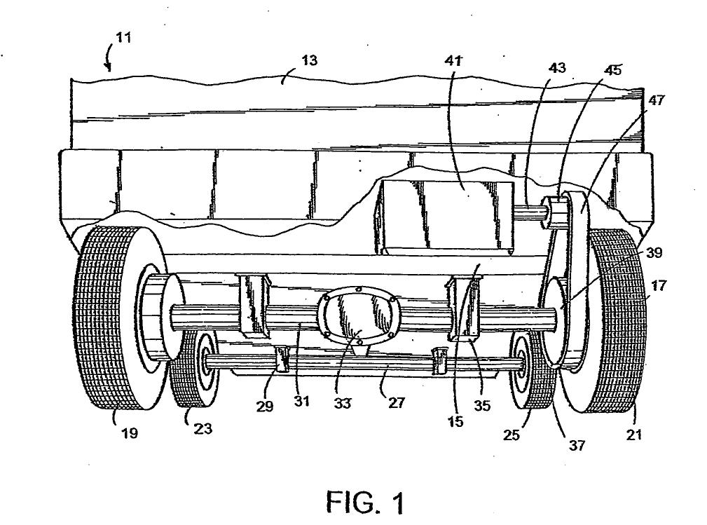

Referring now to FIG. 1, the rear of the motor vehicle 11 is shown. The motor vehicle 11 has a body 13 supported by a frame 15. The motor vehicle 11 is mounted on and moves and rolls on four wheels 17, including a left rear wheel 19 and a right rear wheel 21 and also a left front wheel 23 and a right front wheel 25. The right front wheel 25 is situated on a front axial 27. The front axial 27 is mounted on the frame 15 beneath the frame 15. Front supports 29 connect the front axial 27 to the frame 15. The left rear wheel 19 and the right rear wheel 21 rotate on a rear axial 31. The rear axial 31, as is common in motor vehicles in general, has a differential 33 to permit turning of the motor vehicle 11. Both rear supports 35 secure the rear axial 31 to the frame 15.

Brake drums 37 are commonly used in motor vehicles to permit braking of the motor vehicle. Depression of a foot pedal (not shown) forces a brake shoe against the brake drum 37 providing friction which slows an ultimately stops the motor vehicle 11. In accordance with the invention, the brake drum 37 which normally is within each of the four wheels 17, and is shown on FIG. 1 on the right real wheel 21, extends outwardly toward the differential 33. In this manner, there is a brake drum 37 within the right rear wheel 21, as has been previously commonly used, and a brake drum extension which extends outside of the right rear wheel 21. A drive pulley 39 is formed from that part of the brake drum 37 which is outside of the right rear wheel and has the same diameter as the brake drum 37.

Mounted on the frame 15 is an electric generation unit 41. The electric generation unit 41 may be a direct current generator or an alternator with a converter to convert the alternating electric current to direct current. As is well known, direct current 5 is generally utilized in motor vehicles as batteries produce direct current, and direct current motors, particularly series would direct current motors, are known to serve as a source of rotational power in electric vehicles such as trolley cars. The electric generation unit 41 has a generator shaft 43 with a generator pulley 45 on the generator shaft 43. A drive belt 47 connects the drive pulley 39 and the generator pulley 45 10 causing the drive pulley 39 and the generator pulley 45 to rotate together.

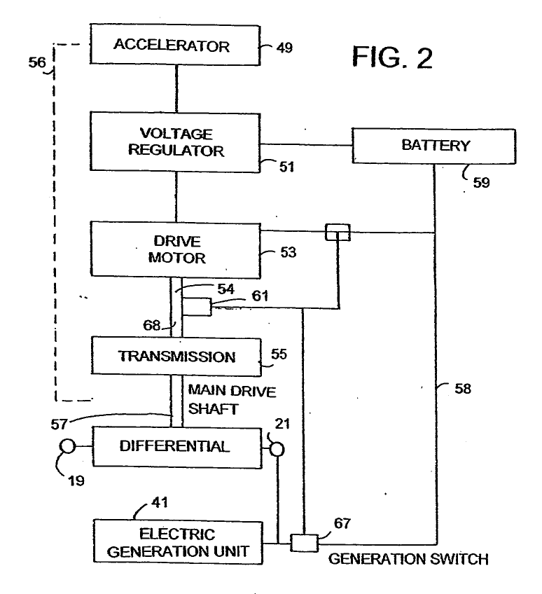

Referring now to FIG. 2, the relationship of the electric generation unit with the overall generation of the motor vehicle can be seen. An accelerator 49 is provided which is used by the operator of the motor vehicle 11 to increase and to decrease the electric power supply to the left rear wheel 19 and the right rear wheel 21 of the motor 1 5 vehicle 11. The accelerator 49 actuates a voltage regulator, which in turn controls drive power output. The voltage regulator 51 is electrically connected to drive motor 53. The drive motor 53 has a motor shaft 54 which in turn, as used in motor vehicles is connected to a transmission 55 to provide rotational power to the transmission 55. The transmission 55 conveys the rotational power to the differential 33 which provides 20 rotational power to the left rear wheel 19 and the right rear wheel 21.

The accelerator 49, voltage regulator 51, drive motor 53 and the transmission 55 form, in combination, an electric drive assembly 56. The transmission 55 has a transmission shaft 57. As has been previously explained and is shown in greater detail in FIG. 1, the differential 33 drives the left rear wheel 19 and the right rear wheel 20, in turn drives the electric generation unit 41.

A power line 58 extends from the electric generator unit 41 to a battery of a series of batteries 59. A speed sensor 61 is located on the drive shaft 65. The drive motor 53 is within the electric drive assembly 56. When the rotational speed of the drive motor 53 is comparatively high, the drive motor 53 is propelling the motor vehicle 11,0 the speed sensor 61 shuts off a switch 67 in the power line 58. When, however, the rotational speed of the drive motor 53s is low, indicating that the motor vehicle 11 is coasting, the switch 67 is closed to deliver electrical power from the electric generator unit 41 to the batteries 59. If the motor vehicle 11 is coasting to a stop, the electric power supplied by the batteries 59 will be limited but the electric generation unit 41 will aid in slowing and in stopping the motor vehicle 11.

Without further analysis, the foregoing will so fully describe the gist of the present invention in that other than by applying current knowledge, readily and apply it for various applications without considering further features that from the standpoint of prior art and constitute essential characteristics of the generic or specific aspects of this invention.

1. An electric motor vehicle including an apparatus for generating electric power from the movement of the motor vehicle:
a frame;
four wheels, the frame being mounted on the four wheels, at least one of the four wheels having a brake drum which extends outside of the wheel to form a drive pulley;
an electric drive assembly connected to at least one of the four wheels;
an electric generation unit having a generator shaft with a generator shaft mounted for supplying electric power to the electric drive assembly; and
a drive belt extending around and engaging both the drive pulley and the generator pulley.

2. An electric motor vehicle according to claim 1 further including the following:
a speed sensor mounted on the electric drive assembly;
a power line connecting the electric generator to the electric drive assembly; and
a switch mounted in the power line, the switch being connected electrically to the speed sensor to open and close the switch.

3. An electric motor vehicle according to claim 1 wherein the electric drive assembly includes a drive motor.

4. An electric motor vehicle according to claim 1 wherein the electric drive assembly includes a transmission.

5. An electric motor vehicle assembly according to claim 1 wherein the electric drive assembly includes a differential.

6. An electric motor vehicle including an apparatus for generation of electric power from the movement of the motor vehicle comprising:
a frame;
a front axial mounted on the frame beneath the frame;
a left front wheel and a right rear front wheel mounted on the front axial;
a rear axial mounted on the frame beneath the frame;
rear wheels including a left rear wheel and a right rear wheel mounted on the rear axial;
a brake drum on at least one of the rear wheels extending outside of the rear wheel toward the other rear wheel forming a drive pulley;
an electric generation unit mounted on the frame having a generator shaft with a generator pulley mounted on the generator shaft, the generator pulley being aligned with the drive pulley; and
a drive belt extending around and engaging both the drive pulley and the generator pulley.

7. An electric motor vehicle according to claim 6 further including an electric drive assembly to drive at least one of the rear wheels.

8. An electric motor vehicle according to claim 6 further including an electric drive assembly to activate at least one of the rear wheels and a speed sensor being mounted on the electric drive assembly.

9. An electric motor vehicle according to claim 6 further including an electric drive assembly to activate at least one of the rear wheels with an electric motor included in the electric drive assembly.

10. An electric motor vehicle including an apparatus for generating electric power from the movement of the motor vehicle comprising:
a frame;
a pair of front wheels;
means for mounting the front wheels on the frame;
a left rear wheel and a right rear wheel;
means for mounting the rear wheels on the frame at least one of the rear wheels including a brake drum which extends outside of the rear wheel toward the other rear wheel to form a drive pulley;
an electric generation unit mounted on the frame having a generator shaft with a generator pulley mounted on the generator shaft, the generator pulley and the drive pulley being aligned with one another;
a drive belt extending around and engaging both the drive pulley and the generator pulley;
an electric drive assembly to drive at least one of the rear wheels;
at least one battery connected to the electric drive assembly;
a power line connecting the electric generation unit to the batteries;
a switch being located in the power line; and
a speed sensor mounted on the electric drive assembly, the speed sensor being connected to the switch to open and close the switch.

11. An electric motor vehicle according to claim 10 wherein the electric drive assembly includes:
an accelerator to control the speed of movement of the motor vehicle;
a voltage regulator activated by the accelerator;
a drive motor having a motor shaft energized through the voltage regulator;
a transmission connected to the motor shaft and including a transmission shaft; and
a differential, the transmission shaft being connected to the differential, the differential being connected to the rear wheels.
